(19) United States
(12) Patent Application Publication
(10) Pub. No.: US 2006/0161774 A1
(43) Pub. Date: Jul. 20, 2006

(54) Authentication method and system between device with small computational resources and device using public key

(75) Inventors: Mi-suk Huh, Suwon-si (KR); Kyung-hee Lee, Yongin-si (KR); Bae-eun Jung, Seongnam-si (KR); Yung-ji Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/327,435

(22) Filed: Jan. 9, 2006

(30) Foreign Application Priority Data
Jan. 14, 2005 (KR) 2005-0003727

(51) Int. Cl. H04L 9/32; H04L 9/00; G06F 15/16; G06F 17/30; G06F 7/04; G06F 7/58; G06K 19/00; G06K 9/00

(52) U.S. Cl. 713/168; 726/3; 726/9

(57) ABSTRACT

An authentication method and system are provided for devices in a home network. The device authentication method includes: storing a secret key list that contains IDs of computationally weak devices without public key operational capabilities, each ID being provided from the respective computationally weak device, and secret keys corresponding to the IDs; receiving session information including a session from a computationally weak device; operating the session information based on the secret key list, and authenticating the computationally weak device; if the computationally weak device is authenticated, generating authentication acknowledgement information about the session information and the authentication of the computationally weak device, and transmitting the information to a general device with public key operational capabilities; and at the general device, carrying out an operation on the received session information and extracting the session.

### CROSS-REFERENCE TO RELATED APPLICATIONS

This application claims benefit under 35 U.S.C. § 119 from Korean Patent Application No. 2005-03727, filed on Jan. 14, 2005, the entire content of which is incorporated herein by reference.

### BACKGROUND OF THE INVENTION

1. Field of the Invention

Methods and systems consistent with the present invention relate in general to authentication for home devices connected to a home network, and more specifically, to authentication between a computationally weak party which cannot perform a public key operation and a party which can perform a public key operation party using a server for devices with small computational resources.

2. Description of the Related Art

A Public Key Infrastructure (PKI) enables users to be authenticated to each other in use of encryption and digital signatures through a public key algorithm. The PKI uses public keys consisting of encryption keys and decryption keys to encrypt and decrypt messages, and provides a digital certificate that can authenticate users.

Usually, authentication between devices with small computational resources that cannot perform a public key operation in the PKI and devices using public keys is difficult.

Even though a device with a public key operational capability may perform authentication by sharing a secret key of a device with small computational resources, since both devices must store secret keys of every computationally weak device, effective authentication cannot be performed.

The authentication method disclosed in U.S. Pat. No. 5,222,140 suggested that a computationally weak device should provide an encrypted secret key to a control unit using the Rabin system, and the control unit should decrypt the encrypted secret key by using its own secret key so that two devices share a session key.

In this case, however, since the information on a computationally weak device is not used as secret information between two devices, authentication for the weak device is not possible. Thus, although a session key may have been shared, it is not certain whether the session key is shared with a device to be authenticated.

Similarly, U.S. Pat. No. 5,299,263 disclosed a method for achieving mutual authentication and session key agreement between two devices, one of them having weak computational resources and the other having strong computational resources. Here, the weak computational side carries out an exponential operation and an inverse operation of the exponential operation on a random number in advance, and uses the results for every protocol whenever necessary. Therefore, a modular square root operation can be performed, and especially computationally weak devices requiring a substantial amount of time for the operation can benefit by the method.

However, the computationally weak device has to carry out the exponential operation every time it accesses a server, and although it usually does so in advance to share a key with the server, it also needs to carry out the exponential operation on a random number. If the pre-operation were completed within several minutes, the mutual authentication method would be very useful. However, in practice, the pre-operation takes a considerable amount of time, and many devices often require a shared key at the same time period. Especially in the latter case, if key sharing fails, the devices have to try again. Therefore, the above-described method is not efficient for all cases.

### SUMMARY OF THE INVENTION

The present invention provides an efficient authentication method and system between devices in a home network, in which one device uses a computationally weak device server and thus, is incapable of performing a public key operation, whereas the other device has a public key operational capability.

According to an aspect of the present invention, there is provided an authentication method for a device in a home network, the method comprising: storing a secret key list that contains IDs of computationally weak devices without public key operational capabilities, each ID being provided from the respective computationally weak device, and secret keys corresponding to the IDs; receiving session information including a session from a computationally weak device; operating the session information based on the secret key list, and authenticating the computationally weak device; if the computationally weak device is authenticated, generating authentication acknowledgement information about the session information and the authentication of the computationally weak device, and transmitting the information to a general device with public key operational capabilities; and at the general device, carrying out an operation on the received session information and extracting the session.

The session information contains ID of the computationally weak device, ID of the general device, session key information and ID of the computationally weak device being shared with the general device, and an operational value of the general device's ID and the session key information.

In addition, the authentication acknowledgement information includes the information on a server for computationally weak devices having the secret key list.

In an exemplary embodiment of the invention, the method according further comprises at the computationally weak device and the general device, storing and storing the public key list, wherein the public key list contains ID of the general device and public key information corresponding to the ID.

Another aspect of the present invention provides an authentication method for a device in a home network, the method comprising: storing a public key list containing IDs of general devices and public key information corresponding to the respective IDs; receiving a message including message information from one of the general devices having public key operational capabilities; and authenticating the message of the general device by referring to the public key list.

The message further includes ID of the general device, public key information corresponding to the ID, ID of a computationally weak device, and a replay attack prevention information.

Still another aspect of the present invention provides an authentication method for a device in a home network, the method comprising: storing a public key list containing IDs of general devices and public key information corresponding to the respective IDs; receiving from a mobile device ID of a computationally device, secret key information including a secret key of the computationally weak device and authentication information for the computationally weak device; searching the public key list for public key information of the mobile device, and based on the public key information, authenticating the authentication information; if the authentication information is authenticated, extracting the secret key from the secret key information of the computationally weak device; and recording and storing ID and the extracted secret key of the computationally weak device.

If the secret key information and authentication information for the computationally weak device cannot be received through a limited location channel connected to the computationally weak device, the information is received from the mobile device instead.

In addition, the authentication information receiving step comprises at the mobile device, transmitting the public key list to the computationally weak device via a limited location channel, wherein the mobile device having received the authentication information containing the ID and secret key information of the computationally device from the computationally weak device itself transmits the authentication information.

The authentication information for the computationally weak device includes an operation value of the public key operation carried out by the mobile device.

Yet another aspect of the present invention provides an authentication system for a device in a home network, including: a database module for storing a public key list that contains IDs of general devices and public key information corresponding to the respective IDs; a search module for searching the database module for IDs of general devices with public key operational capabilities and public key information of the general devices to be compared; an operation module for performing an operation on session information provided from the general devices, or generating authentication acknowledgement information for authentication of the general devices; a communication module for transmitting the public key list through a limited location channel; and a general communication module for receiving the session information from a computationally weak device without public key operational capabilities, and transmitting the session information and the authentication acknowledgement information to the general devices.

The database module stores a secret key list containing IDs of computationally weak devices, and secret keys corresponding to the respective IDs.

### BRIEF DESCRIPTION OF THE DRAWINGS

The above and/or other aspects of the present invention will be more apparent by describing exemplary embodiments of the present invention with reference to the accompanying drawings, in which:

FIG. 1 is a flow chart explaining an authentication method between a computationally weak device and a general device, according to an exemplary embodiment of the present invention;

FIG. 2 illustrates an exemplary embodiment of authentication between a computationally weak device and a general device;

FIG. 3 is a flow chart explaining how a computationally weak device authenticates a relatively simple message, such as “Control a device”, according to an exemplary embodiment of the present invention;

FIG. 4 illustrates an exemplary embodiment of sending a message from a computationally weak device to a general device;

FIG. 5 is a flow chart explaining a method for registering a device having small computational resources with a server for computationally weak devices according to an exemplary embodiment of the present invention;

FIG. 6 illustrates an example of the registration of a computationally weak device with a server for computationally weak devices, according to an exemplary embodiment of the present invention; and

FIG. 7 is a schematic block diagram of a device authentication system according to an exemplary embodiment of the present invention.

### DETAILED DESCRIPTION OF THE EXEMPLARY EMBODIMENTS

Exemplary embodiments of the present invention will be described herein below with reference to the accompanying drawings.

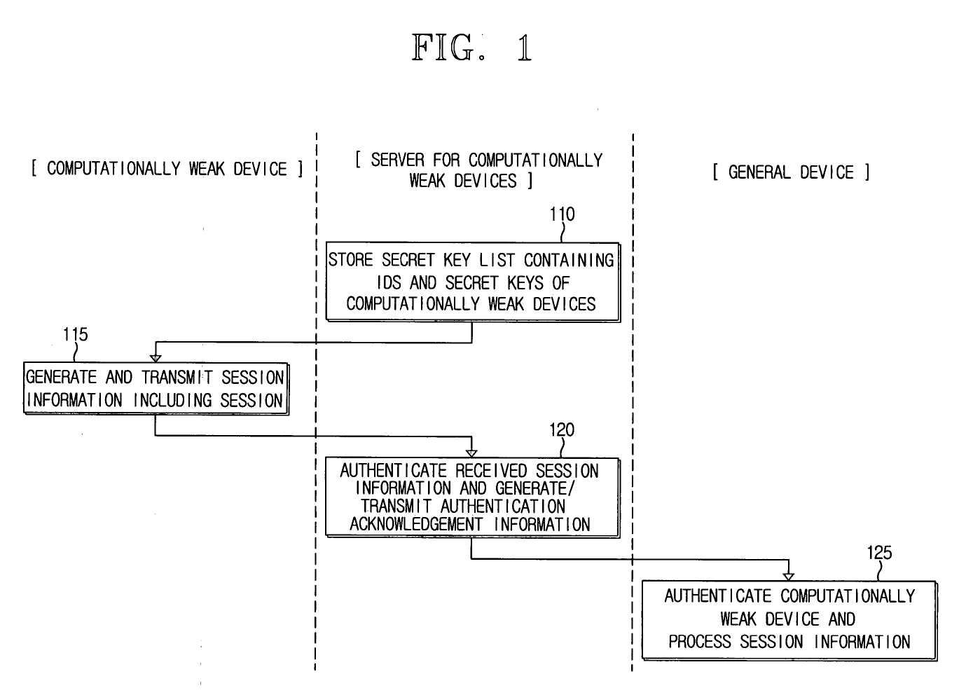

FIG. 1 is a flow chart explaining an authentication method between a computationally weak device and a general device (i.e., a computationally strong device), according to an exemplary embodiment of the present invention.

In operation S110, a server for devices with small computational resources (hereinafter referred to as ‘a server for computationally weak devices’) stores a secret key list containing IDs of computationally weak devices (i.e., devices having lower computational capabilities) that cannot perform public key operations, and secret keys corresponding to the IDs.

The server for computationally weak devices performs a public key operation in behalf of computationally weak devices that cannot perform complicated public key operations. The computationally weak devices register their IDs and secret keys with the server. These IDs and secret keys are recorded and stored in the server, and are not shared with general devices. Similar to general devices, the server for computationally weak devices has a computational capability, so it can perform a public key operation. In addition to the IDs and secret keys of the computationally weak devices, the server also stores information about IDs of general devices and public keys corresponding to the IDs.

The IDs and secret keys of each computationally weak device are tabulated to form a list called ‘secret key list. In a similar manner, the IDs and public keys of general devices (computationally strong devices) are tabulated to form a list called ‘public key list’.

Public key information indicates a public key itself of a general device or part of the public key or a converted value of a public key being compressed to a function. In general, devices with substantial computational resources and public key operational capabilities have their own public keys. Since each device has a different public key, the public key is considered as an intrinsic value. Therefore, the public key information differs by devices as well.

Computationally weak devices, the server for computationally weak devices, and general devices all have public key lists, and based on the lists they perform authentication with general devices in a home network.

In operation S115, a computationally weak device generates session information containing a session to be transferred to a general device, and transmits the information to the server for computationally weak devices.

If a user accessed to a certain computationally weak device wishes to transfer a session to a general device, the computationally weak device generates session information for the general device with reference to a public key list. The session information consists of the computationally weak device's ID, the general device's ID, and a Hash algorithm for a secret key of the computationally weak device. The session information is a value provided by the computationally weak device that carried out a necessary operation with its ID and the public key information of the general device, and contains a session to be transferred to the general device. In addition, the computationally weak device generates authentication information using its secret key, and transmits it to the server.

In operation S120, the server performs an operation for authentication on the session information from the computationally weak device, generates authentication acknowledgement information, and transmits it to the general device.

The server performs authentication for the computationally weak device. The computationally weak device transmits a Hash algorithm for its secret key to the server, so that the server can authenticate the computationally weak device through the session information. The secret key shared between the computationally weak device and the server makes it possible for the server to operate the session information for authentication of the device. In more detail, the server performs a necessary operation on the session information to search the secret key of the computationally weak device. Moreover, by referring to the secret key list, the server determines whether the secret key being searched out corresponds to the ID of the computationally weak device.

As aforementioned, the server searches the secret key list, and performs an operation on the ID and session information of the computationally weak device. If it turns out that the session information corresponds to the ID, the server authenticates that the session information has been provided from the computationally weak device. In this manner, it is verified that the computationally weak device of interest was indeed registered with the secret key list.

Although the server for computationally weak devices is able to authenticate a computationally weak device having transmitted session information by carrying out a necessary operation on the session information, it cannot determine a session to be transferred to a general device. This is because the session contained in the session information is processed carefully so that only its final destination, i.e., a general device, can determine the content of a message.

Upon acknowledging the receipt of the session information from a computationally weak device recorded in the secret key list, the server generates authentication acknowledgement information, verifying that the session information has been issued from a reliable device. Here, the authentication acknowledgement information includes public key information about the server for computationally weak devices, so it verifies that the computationally weak device has issued to the authentication acknowledgement information. Meanwhile, the general device can easily determine, by referring to its public key list, that the server for computationally weak devices is a registered device of the home network.

In operation S125, after receiving the session information and the authentication acknowledgement information from the computationally weak device of interest, the general device authenticates the computationally weak device through the authentication acknowledgement information.

Unlike the server for computationally weak devices, the general device does not store the secret key list. For this reason, the general device does not know the ID and secret key of the computationally weak device and thus, cannot determine whether the computationally weak device is a registered device of the home network. Therefore, the server for computationally weak devices provides the general device with the session information of the computationally weak device and its authentication acknowledgement information, in order to verify to the general device that the computationally weak device of interest is a registered device of the home network. In response, the general device performs an operation for acknowledging the session information from the computationally weak device. More specifically, the general device performs an operation on the session information using its public key information, and extracts a session from the session information. Only through the general device's public key information can a user determine the session being input into the computationally weak device.

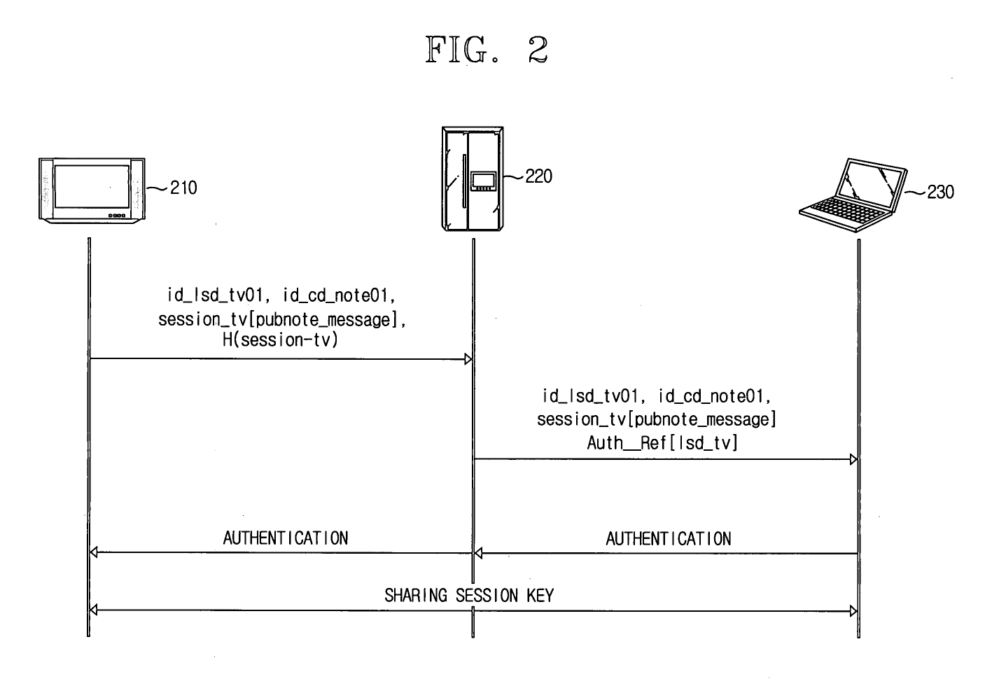

FIG. 2 illustrates an exemplary embodiment of authentication between a computationally weak device and a general device (i.e., a computationally strong device).

A user accesses a television (TV) 210 which is a computationally weak device, and transfers a command to a notebook computer 230 which is a computationally strong device. Here, a refrigerator 220 functions as a server for computationally weak devices.

The TV 210 and the refrigerator 220 share a secret key. Also, the refrigerator 220 stores a secret key list containing the ID and secret key of the TV 210.

Table 1 below illustrates the secret key list of the refrigerator 220.

TABLE 1

| Computationally weak | | |
|---|---|---|
| device | ID | Secret key |
| Microwave oven | id_lsd_range03 | scretkey_range03 |
| TV | id_lsd_tv01 | scretkey_tv01 |
| Heater | id_lsd_heat04 | scretkey_heat04 |
| Interphone | id_lsd_inte18 | scretkey_inte18 |

As can be seen in Table 1, the TV 210 has an ID called ‘id_lsd_tv01’, and a secret key such as ‘scretket_tv01’. At this time, the notebook computer 230 has an ID called ‘id_cd_note01’, and public key information such as ‘publickey_note01’.

To transfer a command to the notebook computer 230, the TV 210 generates and transmits session information to the refrigerator 220. Here, the session information consists of the ID for the TV 210, the ID for the notebook computer 230, a session value, a Hash algorithm etc. The session information is obtained through a predetermined computational operation using the ID for the TV 210 and the public key information of the notebook computer 230. In addition, the session information includes a session the user wants to send to the notebook computer 230, and this is concealed unless the notebook computer 230 performs a public key operation using its secret key. The session information provided from the TV 210 to the refrigerator 220 looks like ‘session_tv[pubnote_message]’.

Since the TV 210 is a computationally weak device, it cannot perform a complicated public key operation and takes a great amount of time even for a simple public key operation. Therefore, it is preferable that a computationally weak device including the TV 210 performs a simple secret key operation instead of a complicated, time-consuming public key operation.

A Hash algorithm enables the server for computationally weak devices, e.g., the refrigerator 220, to authenticate the session information from the TV 210. Suppose that a Hash algorithm transmitted from the TV 210 is ‘H(session_tv)’. Then, the refrigerator 220 receives the session information ‘session_tv[pubnote_message]’ from the TV 210 and its hashed value using the shared key ‘scretkey_tv01’ between the TV 210 and the refrigerator 220, and carries out an operation based on the Hash algorithm by using the secret key that shares the session information from the TV 210. If the result of the Hash algorithm-based operation coincides with the hashed value transmitted from the TV 210, it means that the session information came from the registered TV 210 of the secret key list.

The refrigerator 220 acknowledges the session information of the TV 210, and generates authentication acknowledgement information accordingly. The authentication acknowledgement information is the information for verifying that the session information of the TV 210 is safe information transmitted from a reliable device, and includes information about the refrigerator 220, the server for computationally weak devices. The final destination, i.e., the notebook computer 230, of the session included in the session information does not have the secret key list, so it does not know the ID and secret key of the TV 210.

In case that the session information is transferred from the TV 210 directly to the notebook computer 230 without going through the refrigerator 220, the notebook computer 230 can only check the transmitted session information without authentication. Unlike the refrigerator 220, the notebook computer 230 does not have the secret key list of computationally weak devices. This is why the notebook computer 230 is not able to determine whether the TV 210 is a registered device of the home network. Through the authentication acknowledgement information, the refrigerator 220 guarantees that the TV 210 is a registered device of the home network, and that the session information of the TV 210 is safe.

Even though the notebook computer 230 cannot directly perform authentication for the TV 210, the computationally weak device, the refrigerator 220 is already aware that the TV 210 is a registered device of the home network. Since the server for computationally weak devices should be able to perform a public key operation, the refrigerator 220 has registered IDs of the home network and public key information corresponding to the IDs. Based on the ID and public key information of the refrigerator 220, the notebook computer 230 authenticates the refrigerator 220.

All of the TV 210, the refrigerator 220, and the notebook computer 230 have the public key list. The public key list contains IDs of all devices having public key information, and the public key information corresponding to those IDs.

Every registered device of the home network has the public key list. Therefore, when one of these devices having the public key information requests an access to another device, authentication is performed by checking the secret key corresponding to the public key information of the device out of the public key list. Meanwhile, the device having received the request searches the public key list for the ID and public key information of the device that requested an access. If a computationally strong device using public key information joins the home network, the user records the device's ID and public key information in the public key list, and completes the registration of the device to the home network.

The ID and public key information of the refrigerator 220 are recorded on the public key list stored in the notebook computer 230, and the notebook computer 230 authenticates that the refrigerator 220 is a reliable device. In addition, the notebook computer 230 concludes that not only the authentication acknowledgement information from the refrigerator 220 which is the registered device of the home network but also the session information transmitted via the refrigerator are safe. In effect, through the authentication acknowledgement information the refrigerator 220 guarantees the safety of the TV 210, so the notebook computer 230 decides that the session information issued by the TV 210 is also safe.

The notebook computer 230 performs an operation on the session information using the secret key corresponding to the public key information. In detail, the session information contains the public key information of the notebook computer 230, and the notebook computer 230 performs an operation on the session information using the secret key corresponding to its public key information. Through the operation, the notebook computer 230 extracts the session that the TV intended to send to the notebook computer 230.

For example, suppose that the session that the TV 210 transmitted to the notebook computer 230 through the session information is a session key for image transmission between two devices. Then, the notebook computer 230 extracts the session key by performing an operation on the session information, and in this manner the notebook computer 230 and the TV 210 share the session key together.

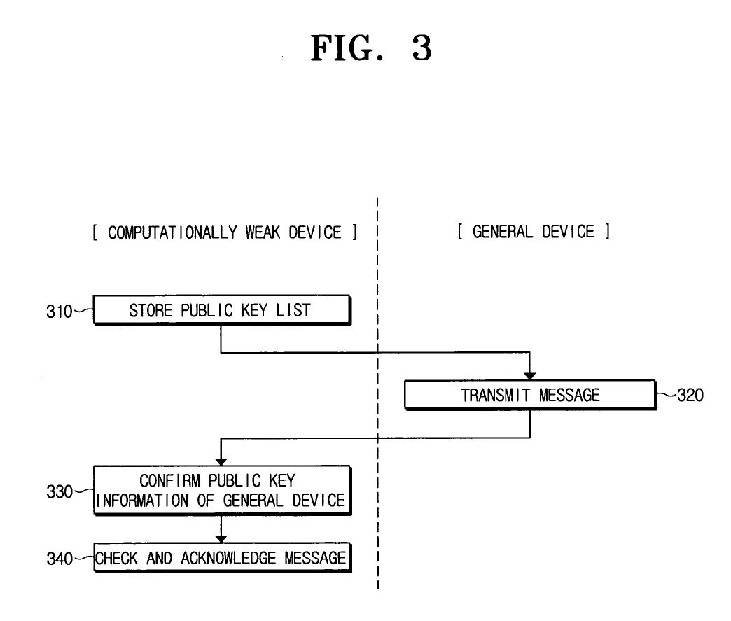

FIG. 3 is a flow chart explaining how a computationally weak device authenticates a relatively simple message, such as “Control a device”, according to the present invention.

At first, in operation S310, the computationally weak device stores a public key list. Next, in operation S320, the general device (i.e., a computationally strong device) transmits a message to the computationally weak device.

Usually, the message consists of the computationally weak device's ID, the general device's ID, the public key information of the general device, message information to be transferred to the computationally weak device, and an operation value of the message information. The operation of the message information is carried out by using a secret key corresponding to the public key information of the general device. Particularly, the operation value is a value that can be restored by a public key operation even the computationally weak device can perform.

In operation S330, the computationally weak device authenticates the general device by using the public key list.

In detail, the computationally weak device searches the public key list to compare it with the general device's ID and public key information provided by the general device. If the comparison result says that the IDs and the public key information are identical, the public key information of the general device is acknowledged. On the other hand, if the comparison result says that the IDs and the public key information are different, authentication fails and the computationally weak device can disconnect the general device (i.e., the computationally strong device). As aforementioned, the acknowledgement of the public key information of the general device can be done simply by comparing the general device's ID and public key information with those in the public key list. Thus, the computationally weak device does not have to carry out a separate public key operation.

In operation S340, the computationally weak device checks and acknowledges the message provided from the general device.

This operation is conducted after the computationally weak device confirms the public key information of the general device referring to the public key list. Meanwhile, the message from the general device contains message information that the general device intended to send to the computationally weak device, and is a value calculated through the public key operation. To this end, the general device carries out a complicated computation including the public key operation before transmitting the message to the computationally weak device. Preferably, the general device sets the message to a value that the computationally weak device can extract the message information therefrom through a simple operation. In this manner, the computationally weak device can extract the message information of the general device through a simple operation (e.g., the square calculation), and check the message. Then, the computationally weak device sends a receipt acknowledgement message to the general device to inform that message information included in the message has been arrived safely.

Through this operational procedure, the computationally weak device acknowledges the message information included in the message from the general device, and executes a necessary job.

For instance, if the message information says ‘Stay in standby mode’, the computationally weak device is kept on or in standby mode. For another example, if the message information says ‘Switch to power saving mode’, the computationally weak device is turned to power saving mode.

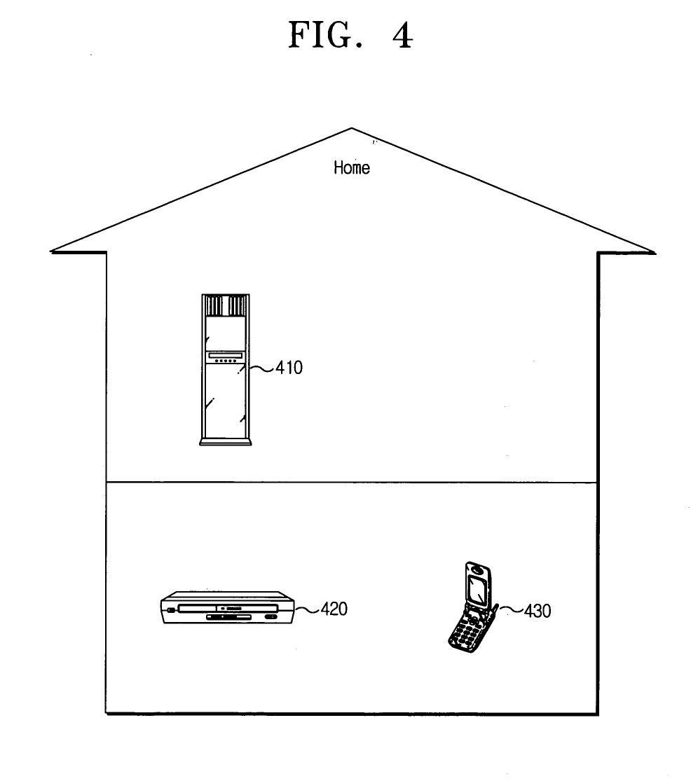

FIG. 4 illustrates an exemplary embodiment of sending a message from a computationally weak device to a general device (i.e., a computationally strong device) in accordance with the present invention.

In this exemplary embodiment, an air conditioner 410 and a VCR 420 correspond to computationally weak devices, and a cellular phone 430 corresponds to the general device. The air conditioner's ID is ‘ID_air3904’, the VCR's ID is ‘ID_video608’, and the cellular phones ID is ‘ID_phone939’. Also, the public key information of the cellular phone 420 is ‘Pub_phone939’.

Suppose that a user wants to set the indoor temperature on the second floor to 18° C. using the air conditioner 410 installed in the second floor. However, suppose that the user is currently on the first floor. In this case, the user uses the cellular phone 430 to operate the air conditioner 410 of the second floor, so that the indoor temperature of the second floor can be set at 18° C. as desired.

To this end, the cellular phone 430 transmits to the air conditioner 410 a message including the air conditioner's ID, the cellular phone's ID and public key information, and message information. The message is resulted from a complicate public key operation on the air conditioner's ID, ID_air3904, the cellular phone's public key information, Pub_phone939, and the message information. The resulting value is ‘Air3094_Pubphone[Message]’. Although the cellular phone 430, which is a computationally strong device with public key operational capabilities, calculated the message ‘Air3094_Pubphone[Message]’ through the complicate computation, the computationally weak air conditioner 410 without public key operational capabilities should be easily able to get the cellular phone's ID and public key information through a square calculation. This enables the air conditioner 410 to confirm that the message ‘Air3094_Pubphone[Message]’ came from the cellular phone 430 and was destined to the air conditioner 410.

Moreover, the message includes a replay attack prevention information. Here, ‘replay attack’ is an action that an unauthorized user makes illegal access to the home network by obtaining the information a home networked device uses, and sends a message that has already been used before, while pretending to be an authorized user. The information for preventing this replay attack is the replay attack prevention information.

The cellular phone 430 sends the replay attack prevention information with the message to the air conditioner 410, so that no unauthorized user can access the home network and operate the air conditioner 410 using a false message.

If the message information input to the user's cellular phone 430 says, “Maintain the indoor temperature at 18° C.”, the air conditioner 410, the destination of the message, carries out an operation on the message ‘Air3094_Pubphone[Message]’ to check the message information, and executes an air conditioning process or a heating process to keep the indoor temperature at 18° C.

In a similar manner, suppose that the user wants to record a TV program on the VCR 420. Again, the user can use his cellular phone 430 to transmit a control command to the VCR 420. In other words, the cellular phone 430 generates a message as the user input, and transmits the message to the VCR 420. Suppose that the message information says, “Record CH 34 from 02:05 a.m. to 03:05 a.m.” Then, the cellular phone 430 receives the message information from the user and generates a message containing the message information. This message containing the message information is sent to the VCR 420. After performing a predetermined operation, the VCR 420 extracts the message information, i.e., “Record CH 34 from 02:05 a.m. to 03:05 a.m.” from the message, and records TV programs on channel 34 from 02:05 a.m. to 03:05 a.m.

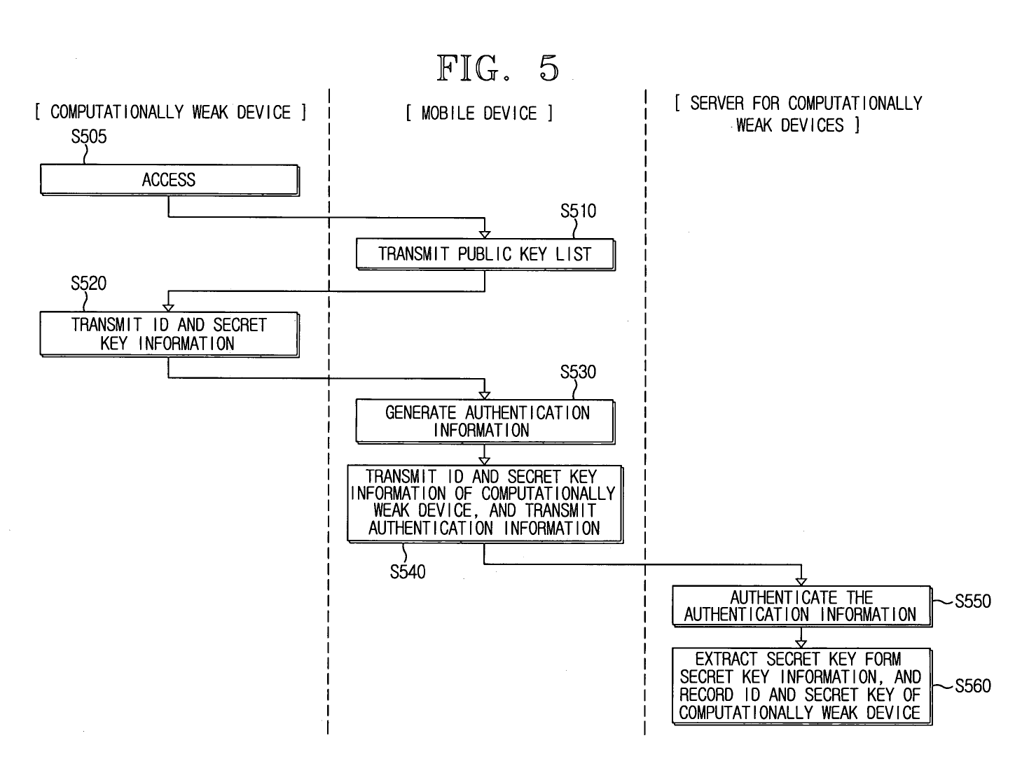

FIG. 5 is a flow chart explaining a method for registering a device having small computational resources with a server for computationally weak devices.

Here, it is assumed that a mobile device and a server for computationally weak devices have a public key list, respectively. The public key list contains IDs of general devices being registered with a home network, and public key information corresponding to those IDs. The public key list looks similar to the one shown in FIG. 1.

As for the mobile device, not only devices having public key operational capabilities and mobile functions, but also devices capable of relaying between computationally weak devices and the servers for computationally weak devices can be used. Examples of the mobile device include cellular phones, personal data assistants (PDAs), etc.

In operation S505, a computationally weak device accesses the mobile device.

At this time, the computationally weak device accessing the mobile device is a device that is not yet registered with the server for computationally weak devices. If the distance between the computationally weak device and the server for computationally weak devices is so far that a limited location channel cannot be formed, the mobile device functions as a repeater. Since it is impossible to register the computationally weak device directly with the server, the mobile device relays between the computationally weak device and the server for the registration of the computationally weak device.

Meanwhile, if the limited location channel is formed between the computationally weak device and the server for computationally weak devices, the mobile device does not have to register the computationally weak device with the server. In this case, the server can obtain the ID and the secret key of the computationally weak device directly from the computationally weak device. Also, by nature of the limited location channel, the user can check the registration status of the computationally weak device within the visual range, so the user can confirm the registration.

Having no limited location channel between the computationally weak device and the server for computationally weak devices means that the mobility between two devices is not flexible. Therefore, in this case, the mobile device might have difficulty in registering the computationally weak device with the server. Therefore, the mobile device, which has relatively good mobility, relays between two devices to register the computationally weak device with the server.

In operation S510, the mobile device transmits the public key list to the computationally weak device.

Then, the computationally weak device searches the public key list for the general device's ID and public key information, and performs authentication of the general device. Since the public key list contains the IDs and public key information of registered general devices of the home network, if a certain device whose ID or public key information is not recorded on the public key list requests an access to the computationally weak device, the computationally weak device readily determines that the device is an unauthorized device simply by searching the public key list. If this is the case, the computationally weak device disconnects the unauthorized device.

In operation S520, the computationally weak device transmits its ID and secret key information to the mobile device.

The secret key information is a value including the secret key of the computationally weak device. It is obtained through a predetermined operation using the public key information of the computationally weak device provided by the public key list from the mobile device. The secret key of the computationally weak device included in the secret key information is revealed only to a computationally weak device having the public key information of enciphered secret key.

Meanwhile, the transmission of the computationally weak device's ID and secret key information to the mobile device is done via the limited location channel, namely, within the user's visual range. Therefore, the user checks the transmission of the computationally weak device's ID and secret key information, and the value transmitted to the mobile device. In this manner, the user is able to monitor whether the communication between two devices is safe. Further, the mobile device regards that the computationally weak device's ID and secret key information provided from the computationally weak device are safe data.

In operation S530, the mobile device generates authentication information.

Here, the authentication information verifies that the computationally weak device's ID and secret key information are safe data causing no harm to the home network. The limited location channel is not formed between the computationally weak device and the server for computationally weak devices, and the user cannot check the registration of the computationally weak device's ID and secret key within his visual range. As explained before, the mobile device in this case is a legally registered device of the home network. By receiving the computationally weak device's ID and secret key through the verified mobile device, the server for computationally weak devices is guaranteed of the safety of the data from the computationally weak device.

Authentication information is an encrypted message through a public key operation of the mobile device. The public key operation of a general device including the mobile device means performing an operation using a personal key corresponding to the public key of the general device (e.g., encryption). Every general device possesses not only a public key but also a personal key corresponding to the public key. In general, a public key operation is performed using a personal key, but a resulting value of the public key operation cannot be solved (deciphered) by the personal key of a general device. To extract a message, the encrypted message through the public key operation is deciphered by the public key of a general device having been recorded on the public key list. The personal key of the general device is usually included in the public key information.

Moreover, authentication information informs that it is issued by the mobile device and at the same time verifies that the computationally weak device's secret information is data transmitted from the server for computationally weak devices. The authentication information is data transmitted from a computationally weak device having safe secret key information to the home network, and verifies the safety of the computationally weak device that issued the data. By including the encrypted message by means of the resulting value of the mobile device's public key operation to the authentication information, the server for computationally weak devices determines that the mobile device has received the computationally weak device's ID and secret key. It also determines that the authentication information was issued from the mobile device. As aforementioned, the authentication information is a value obtained through the public key operation of the mobile device. Needless to say, the mobile device is one of general devices with public key operational capabilities.

In operation S540, the mobile device transmits the computationally weak device's ID and secret key information provided from the computationally weak device, and the authentication information generated by itself to the server for computationally weak devices. In operation S550, the server for computationally weak devices performs authentication on the authentication information generated by the mobile device.

In detail, the server for computationally weak devices searches the public key list being stored to determine whether the mobile device has been registered with the home network. Here, the mobile device is a registered device of the home network, and its ID and public key information are recorded on the public key list. The server for computationally weak devices searches the public key list for the mobile device's ID and public key information, decrypts the authentication information by means of the public key information of the mobile device, and compares the decrypted information with an original message. If these two values agree with each other, the server finishes the authentication process on the authentication information. Since the mobile device is verified as a safe device, the data from the mobile device is also regarded as safe.

In operation S560, upon the completion of the authentication of the authentication information, the server for computationally weak devices extracts the secret key of the computationally weak device from the secret key information, and records and keeps the ID and secret key of the computationally weak device.

Now that the authentication information from the mobile device has been authenticated, the server decides that the data provided from the mobile device is also safe. Moreover, the server decides that the ID and secret key of the computationally weak device is a safe data since they are transmitted via the authenticated mobile device.

The server extracts the secret key of the computationally weak device from the ID and secret key information of the computationally weak device. As described before, the secret key information is a value obtained through the operation using the public key information of the server. Thus, only the server can determine the secret key of the computationally weak device through a proper operation.

The server for computationally weak devices is a computationally strong device having public key operational capabilities. It stores and keeps the public key list, and records the ID and secret key of the computationally weak device. Similarly, the computationally weak device records and keeps its ID and secret key.

The secret key list contains IDs and secret keys of computationally weak devices being registered with the home network. Conventionally, the general devices (i.e., computationally strong devices) registered with the home network shared IDs and secret keys of computationally weak devices registered with the home network. However, in the present invention, the server for computationally weak devices manages IDs and secret keys of the computationally weak devices. As explained before, as for authentication between the computationally weak device and the computationally strong device, the server performs the public key operation in behalf of the computationally weak device, and proves to the computationally strong device that the computationally weak device is a registered device with the home network.

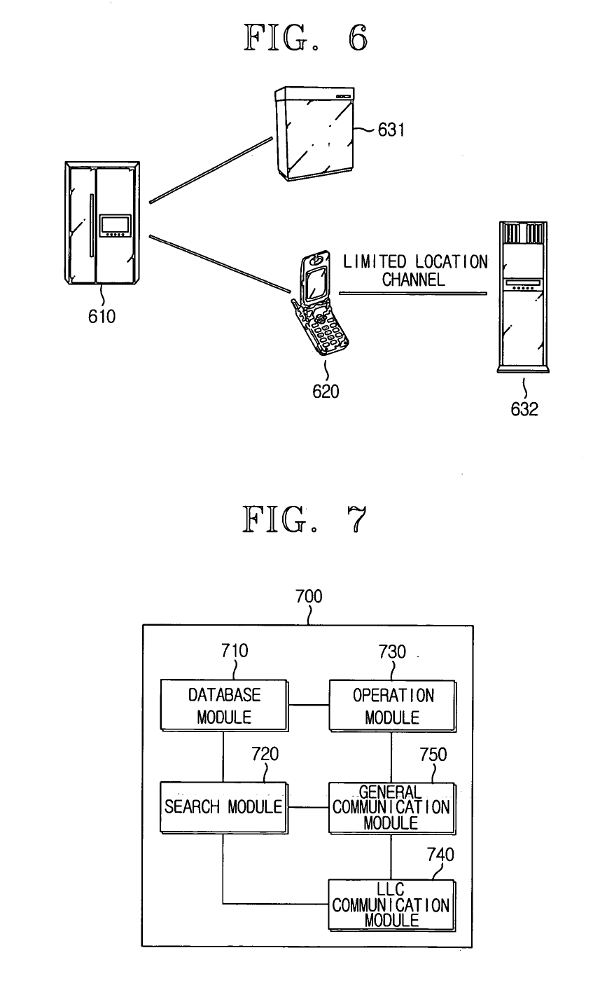

FIG. 6 illustrates an example of the registration of a computationally weak device with the server for computationally weak devices, according to the present invention.

Here, a reference numeral 610 indicates the server for computationally weak device, a reference numeral 620 indicates a mobile device (i.e., a cellular phone), and reference numerals 631 and 632 indicate computationally weak devices. The computationally weak device 631 is located so close to the server that a limited location channel can be formed therebetween, whereas the computationally weak device 632 is located too far from the server 610 to form a limited location channel. The ID and secret key of the computationally weak device 631 are ‘idlsd_d1’ and ‘scrkey_d1’, respectively. Also, the ID and secret key of the computationally weak device 632 are ‘idlsd_d2’ and ‘scrkey_d2’, respectively.

Table 2 shows the public key list the server 610 and the mobile device 620 share together.

TABLE 2

| General device | ID | Public key information |
|---|---|---|
| Server for computationally | id_R1120 | pubkey_r1120 |
| weak devices (R) | | |
| Mobile device (H) | id_H216 | pubkey_h216 |

Suppose that the computationally weak device 631 needs to be registered with the server 610. To this end, the computationally weak device 631 accesses the server, and the server transmits the public key list (Table 2) to the computationally weak device 631. Upon receiving the public key list, the computationally weak device 631 transmits its secret key ‘scrkey_d1’ to the server 610.

Since the computationally weak device 631 is located very close to the server 610 to form a limited location channel, its registration can be done without the help of the mobile device, and the secret key can be transferred directly to the server.

Next, suppose that the computationally weak device 632 needs to be registered with the server 610. Unlike the computationally weak device 631, the computationally weak device 632 is located too far from the server to form a limited location channel therebetween. Thus, the computationally weak device 632 needs to access the mobile device 620 first for its registration with the server 610. Then, the mobile device 620 transmits the public key list (Table 2) to the computationally weak device 632. Similar to the computationally weak device 631, the computationally weak device 632 uses the public key information of the server 610 in the public key list to generate its secret key information, and transmits the generated secret key information and its ID to the mobile device 620. At this time, the communication between the mobile device 620 and the computationally weak device 632 is realized via the limited location channel therebetween.

Upon receiving the ID and secret key information from the computationally weak device 632, the mobile device 620 performs the public key operation and generates authentication information to transmit the ID and secret key of the computationally weak device 632 to the server 610. The authentication information is data for verifying that the secret key information has been transmitted via the mobile device 620, and guarantees the safety of the information. In addition, the authentication information includes a complicated public key operation.

In short, the mobile device 620 transmits the authentication information, the ID and secret key of the computationally weak device 632, and its ID to the server for computationally weak devices 610. Since both ID and secret key information of the mobile device 620 are recorded on the public key list, the server 610 confirms the public key information of the mobile device 620, and acknowledges the authentication information using the public key information, thereby regarding the data from the mobile device 610 as safe. When the authentication process is over, the server 610 performs an operation on the data using its public key information, and extracts the secret key of the computationally weak device 632, which is ‘scrkey_d2’. Since this secret key information is obtained based on the computation with the server's public key information, only the server 610 can extract the secret key of the computationally weak device 632.

Later, the server 610 prepares the secret key list for the computationally weak devices 631, 632 as shown in Table 3 below.

TABLE 3

| Computationally weak | | |
|---|---|---|
| device | ID | Secret key |
| Computationally weak | idlsd_d1 | scrkey_d1 |
| device (D1) | | |
| Computationally weak | idlsd_d2 | scrkey_d2 |
| device (D2) | | |

FIG. 7 is a schematic block diagram of a device authentication system according to the present invention.

Referring to FIG. 7, a device authentication system 700 includes a database module 710, a search module 720, an operation module 730, a limited location channel (LLC) communication module 740, and a general communication module 750.

The database module 700 prepares and stores a public key list that contains IDs of general devices (i.e., computationally strong devices) and public key information corresponding to each ID. Meanwhile, a server for computationally weak devices keeps not only the public key list, but also prepares/regains the secret key list containing IDs of computationally weak devices and secret keys corresponding to the IDs.

Referring to the database module 710, the search module 720 searches and compares the ID and public information of a general device that made an access. When the ID and public key information of the general device coincide with those on the public key list stored in the database module 720, the search module 720 acknowledges the public information of the general device, and verifies that the general device is reliable. In contrast, if the ID and public key information of the general device do not match with those on the public key list, or if such ID and public key information do not exist at all, the authentication process stops and the general device can be disconnected.

The operation module 730 is in charge of the operation required for the authentication of the device. In a computationally weak device, the operation module 730 calculates the secret key information being transmitted to the server for computationally weak devices, and the message information being transmitted to the general device. Here, the operation carried out in the computationally weak device is a square operation which is not complicated. In the general device and the server for computationally weak devices, the operation module 730 performs operations an operation on the message information or the secret key information provided from the computationally weak device, and calculates a corresponding value thereof. The general device and the server for computationally weak devices are capable of performing not only the square operation (which is carried out by the computationally weak device), but also the square root operation. The server for computationally weak devices performs the square root operation in behalf of the computationally weak device, and functions as a relay between the computationally weak device and the general device (i.e., the computationally strong device).

The LLC communication module 740 and the general communication module 750 are in charge of communications between devices. The LLC communication module 740 of the computationally weak device for example access the server for computationally weak devices or the mobile device, in order to register the computationally weak device with the home network. Then, the server for computationally weak devices or the LLC communication module 740 of the mobile device transmits a public key list to the computationally weak device that wants to be accessed. Upon receiving the public key list, the computationally weak device generates secret key information or message information referring to the public key list, and transmits it to back to the general device or another computationally weak device through the general communication module 750. Moreover, the general communication module 750 of the computationally weak device receives the message information from the general device, and transmits it to the operation module 730 to extract the message.

The LLC communication module 740 can be used if a limited location module is available for the registration of a computationally weak device with the server for computationally weak devices. On the other hand, the general communication module 750 is used when communication is conducted through different communication channels but the location limited channel. For instance, wireless LAN is the communication using the general communication module 750.

As explained so far, according to the present invention, effective authentication in the home network can be conducted between computationally weak devices without public key operational capabilities and computationally strong devices with public key operational capabilities, by using the server for computationally weak devices in behalf of the computationally weak devices.

Moreover, the mobile device can be used for the safe registration of computationally weak devices with the server for a computationally weak device, and further for the connection between the computationally weak device and the computationally strong device. Since the general device is connected to the computationally weak devices without sharing IDs and secret keys of all of the computationally weak devices being registered with the home network, overload problem can be reduced. In addition, the computationally weak devices are able to authenticate the general device without carrying out the complicated public key operation.

The foregoing embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. An authentication method for a device in a home network, the method comprising:
storing a public key list that contains identifiers (IDs) of a plurality of computationally weak devices that do not have public key operational capabilities, and secret keys corresponding to the IDs;
receiving session information including a session from a computationally weak device;
authenticating the computationally weak device based on the session information and the secret key list;
if the computationally weak device is authenticated, generating authentication acknowledgement information about the session information and the authentication of the computationally weak device, and transmitting the session information and the authentication acknowledgement information to a general device that has public key operational capabilities; and
at the general device, performing an operation on the session information and extracting the session from the session information.

2. The method according to claim 1, wherein the session information comprises an ID of the computationally weak device, an ID of the general device, session key information and an ID of the computationally weak device being shared with the general device, and an operational value of the ID of the general device and the session key information.

3. The method according to claim 1, wherein the authentication acknowledgement information includes the information on a server for computationally weak devices storing the secret key list.

4. The method according to claim 1, further comprising, at the computationally weak device and the general device, storing a public key list, wherein the public key list contains an ID of the general device and public key information corresponding to the ID.

5. An authentication method for a device in a home network, the method comprising:
storing a public key list containing identifiers (IDs) of a plurality of general devices and public key information corresponding to the respective IDs;
receiving a message including message information from a general device of the plurality of general devices having public key operational capabilities; and
authenticating the message from the general device by referring to the public key list.

6. The method according to claim 5, wherein the message further includes an ID of the general device, public key information corresponding to the ID of the general device, an ID of a computationally weak device, and replay attack prevention information.

7. The method according to claim 5, further comprising checking the message from the general device and sending an acknowledgement message to the general device.

8. An authentication method for a device in a home network, the method comprising:
storing a public key list containing identifiers (IDs) of a plurality of general devices and public key information corresponding to the respective IDs;
receiving from a mobile device an ID of a computationally device, secret key information including a secret key of the computationally weak device and authentication information for the computationally weak device;
searching the public key list for public key information of the mobile device, and based on the public key information, authenticating the authentication information;
if the authentication information is authenticated, extracting the secret key from the secret key information of the computationally weak device; and
storing the ID and the extracted secret key of the computationally weak device.

9. The method according to claim 8, wherein if the secret key information and authentication information for the computationally weak device cannot be received through a limited location channel connected to the computationally weak device, the secret key information and authentication information are received from the mobile device.

10. The method according to claim 8, wherein the receiving comprises, at the mobile device, transmitting the public key list to the computationally weak device via a limited location channel, wherein, the mobile device having received the authentication information containing the ID and secret key information of the computationally device from the computationally weak device itself transmits the authentication information.

11. The method according to claim 8, wherein the authentication information for the computationally weak device includes an operation value of the public key operation performed by the mobile device.

12. An authentication system for a device in a home network, the comprising:
a database module which stores a public key list that contains identifiers (IDs) of general devices and public key information corresponding to the respective IDs;
a search module which searches the database module for IDs of general devices with public key operational capabilities and public key information of the general devices;
an operation module which an operation on session information provided from the general devices, or generates authentication acknowledgement information for authentication of the general devices;
a communication module which transmits the public key list through a limited location channel; and
a general communication module which receives the session information from a computationally weak device without public key operational capabilities, and transmits the session information and the authentication acknowledgement information to the general devices.

13. The system according to claim 12, wherein the database module stores a secret key list containing IDs of computationally weak devices, and secret keys corresponding to the respective IDs.
